(19) United States
(12) Patent Application Publication
(10) Pub. No.: US 2003/0197052 A1
(43) Pub. Date: Oct. 23, 2003

(54) Combination bakery carton and a method of constructing a combination bakery carton

(76) Inventor: Kenneth R. Miess, Elk Grove Village, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/127,388

(22) Filed: Apr. 22, 2002

(51) Int. Cl. B65D 5/00; B31B 49/00; B31B 1/00

(52) U.S. Cl. 229/162.1; 493/51; 229/126

(57) ABSTRACT

A combination carton for displaying bakery goods includes a transparent dome having an integral locking surface. The combination carton further includes a foldable carton portion having a base portion and a lid portion pivotably connected to the base portion. An aperture formed into the lid portion and sized to receive a transparent dome. The transparent dome when disposed within the aperture extends through a plane defined by the lid portion such that the locking mechanism may engage the aperture thereby creating a single combination carton. The combination carton may be formed to include a foldable carton in which the base provides additional storage space for related merchandise.

### FIELD OF THE INVENTION

The present invention relates generally to cartons, such as bakery cartons, and more particularly to a bakery carton that combines a plastic display shell and a paper carton for storing and displaying goods.

### DESCRIPTION OF THE RELATED ART

Folding cartons have long been used by commercial bakeries, such as in-house grocery store bakeries, to store and display bakery goods for sale to consumers. Folding cartons such as these provide ample printable area to include information such as advertisements, coupons, product descriptions, nutritional labels, etc. Typically these folding cartons include a single cellophane or transparent window through which the consumer may view the enclosed product. The limited visibility offered by this window arrangements, however, reduces the chance of a rapid consumer sale or impulse buy.

FIG. 1 illustrates a prior art folding carton constructed in the traditional manner. The carton, generally designated by the numeral 1, includes a plurality of sidewalls 2, a bottom 3 (visible through a window 4) and a top 5. The bottom 3 and the sidewalls 2 intersect along a plurality of fold lines 6 to define an interior 7. The top 5 intersects with at least one of the sidewalls 2 along a fold line 8 to create a lid 9 which corresponds to the top 5, illustrated in the closed position in FIG. 1. The top 5 may be adapted to contain the window 4, as previous described, which may be constructed of cellophane or any other transparent material to allow the consumer to look into the carton 1 and view the contents stored in the interior 7. The window 4 may be attached to the top 5 in any known manner.

Recently, domed containers have been making great inroads into the in-store bakery business replacing and augmenting the traditional folding cartons described above. Plastic domed containers provide excellent product visibility, which is an important factor in merchandising baked goods as impulse purchase items. However, the plastic dome while offering greater visibility than the folding carton, does not provide the printable area on which additional information such as advertisements, nutritional information, product specials, etc. may be displayed.

The folding carton includes sufficient printable area for product advertisement by sacrificing product visibility. The plastic dome, on the other hand, affords excellent visibility by sacrificing area which may be used for product advertising. Due to these limitations, the plastic dome is typically used in a window case to attract consumers while the traditional folding carton is used for special order items which are ordered first by the consumer and seen later. As a result of the limitations of these two carton designs, there exists a need for further improvement

### BRIEF DESCRIPTION OF THE DRAWINGS

FIG. 1 is a perspective view of a prior art folding carton;

FIG. 2 is a perspective view of an embodiment of a combination bakery carton;

FIG. 3 is an enlarged cross-sectional view of a portion of the combination carton shown in FIG. 2;

FIG. 4 is a perspective view of the combination bakery carton shown in an open position;

FIG. 5 is a magnified view of the locking mechanism as seen in FIG. 4;

FIG. 6 is a perspective view of another embodiment of the combination bakery carton;

FIG. 7 is a plan view of a combination bakery carton;

FIG. 8 is a sectional view of a combination bakery carton taken along the section line 6-6;

FIG. 9 is a perspective view of a combination bakery carton in the open position;

FIG. 10 is a sectional view of a combination bakery carton taken along the section line 9-9;

FIG. 11 is a magnified view of another embodiment of the locking mechanism as seen in FIG. 3;

FIG. 12 is a magnified view of another embodiment of the locking mechanism as seen in FIG. 3; and

FIG. 13 is a magnified view of another embodiment of the locking mechanism as seen in FIG. 3.

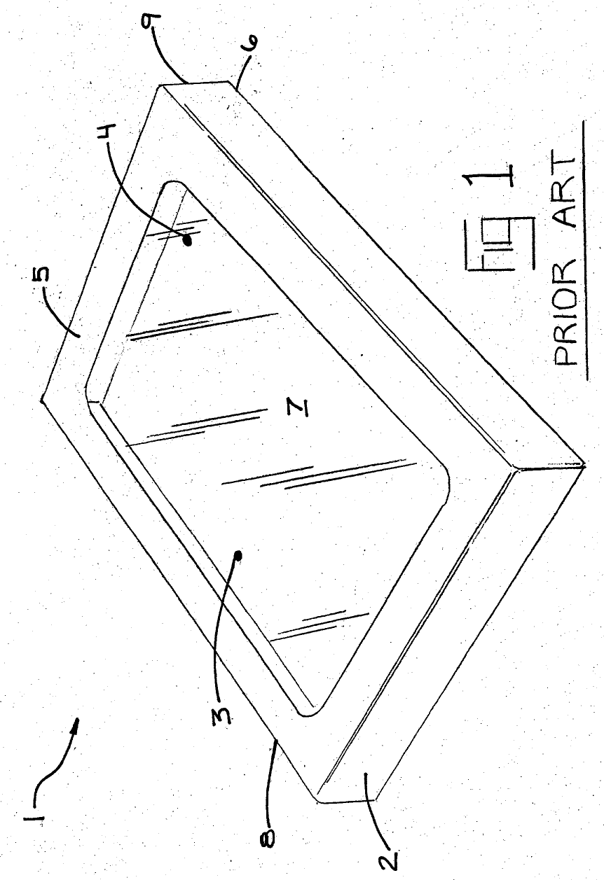

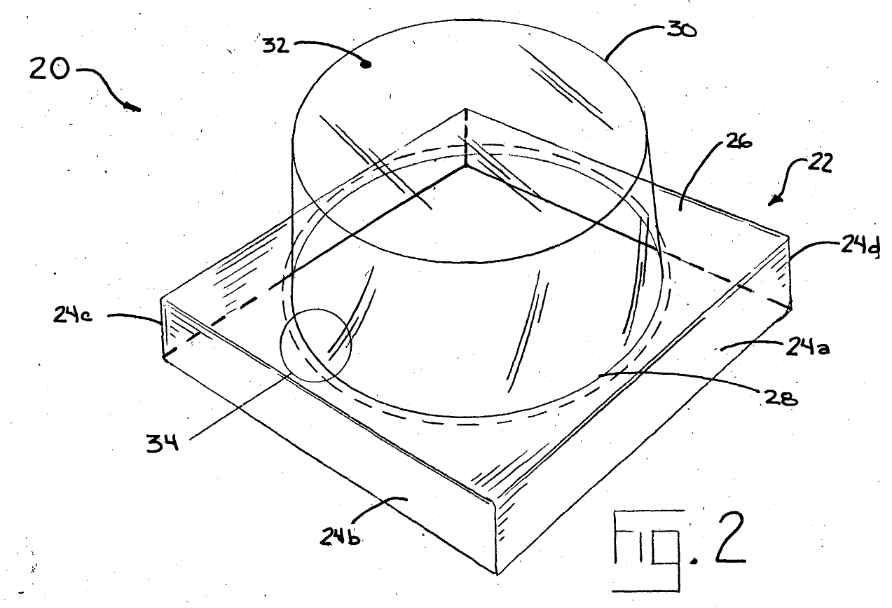

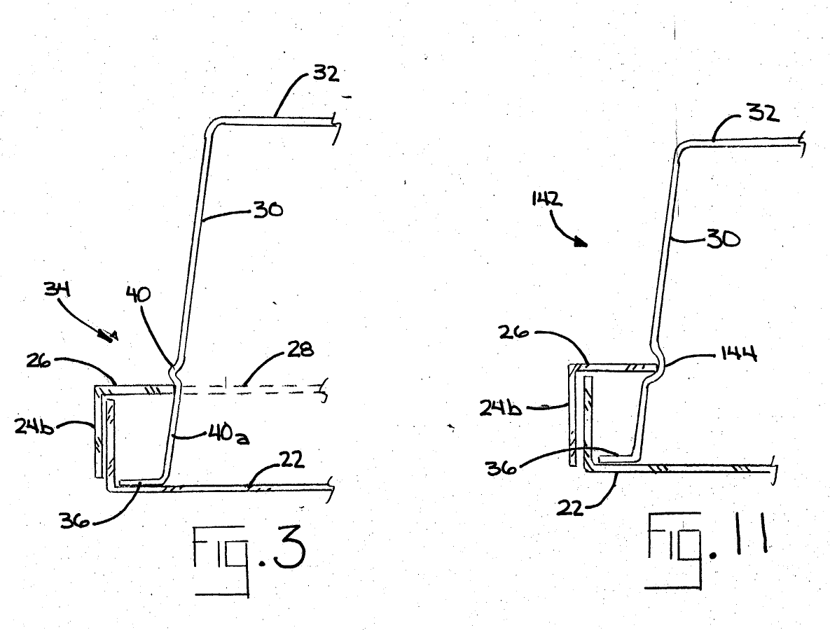

### DESCRIPTION OF THE PREFERRED EMBODIMENTS

An embodiment of a combination carton for displaying bakery goods includes a transparent dome having an integral locking surface. The combination carton further includes a foldable carton portion having a base portion and a lid portion pivotably connected to the base portion. In addition, an aperture is formed within the lid portion and sized to receive the transparent dome. The transparent dome when disposed within the aperture extends through a plane defined by the lid portion such that the locking mechanism may engage the aperture thereby creating a single combination carton.

Further embodiments of the combination carton may include a carton wherein the foldable carton is of a four spot construction. Additional embodiments of the combination carton may include a carton wherein the base portion of the carton provides additional storage space for related merchandise. An additional bottom surface and a plurality of vertical members may act in cooperation with a storage surface to define an enclosed cavity. The enclosed cavity acts in cooperation with the transparent dome to define the combination carton.

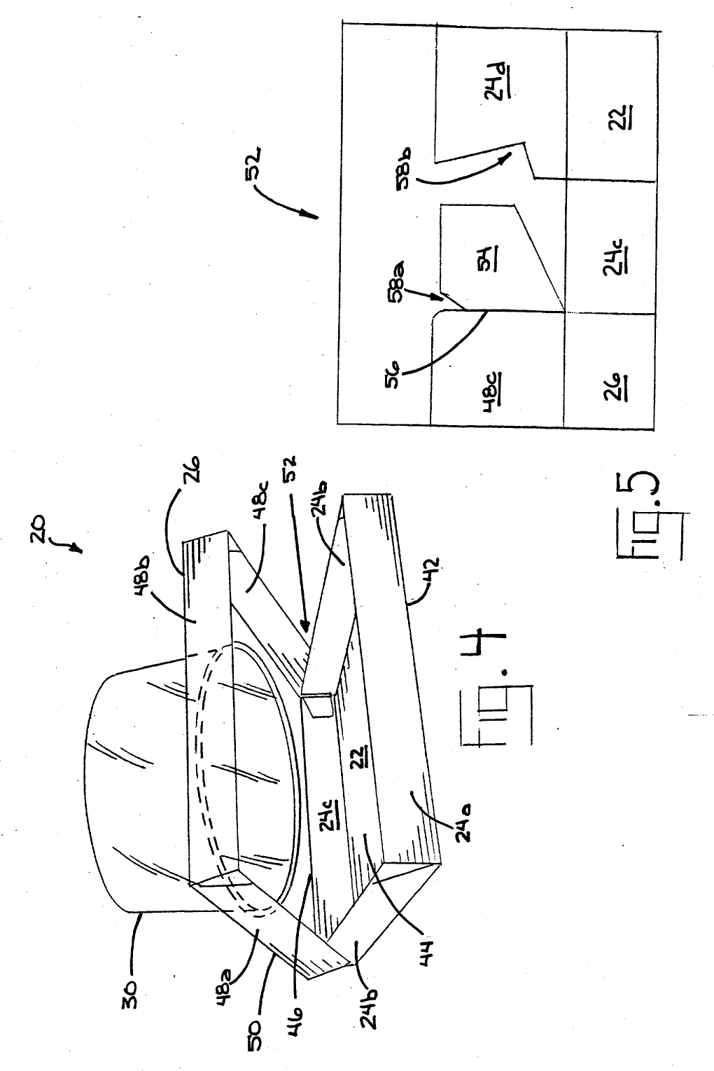

Illustrated in FIG. 2 is a combination bakery carton 20 in an assembled state. The combination bakery carton 20 includes a base portion 22 and a plurality of sidewalls 24a-24d, illustrated in more detail in FIG. 4, and a plurality of covers 48a-48c. A top portion 26 having an aperture 28 is pivotably connected to at least one of the sidewalls 24a-24d or covers 48a48c. A transparent dome 30 may be disposed within the aperture 28 such that the top surface 32 of the dome 30 is above the plane defined by the top portion 26 when the top portion 26 is in the closed configuration.

A locking mechanism 34 illustrated in detail in FIG. 3 (highlighted by a balloon in FIG. 2) is shown in detail. The top portion 26 engages the locking mechanism 34 of the transparent dome 30 when the transparent dome 30 is disposed within the aperture 28. The base portion 22 is in contact with a lip 36 and while the raised member 40 is secured into position by the top portion 26. The top portion 26 and the aperture 28 are retained by the convex surface 38 defined by the relative height difference between the raised mechanism 40 and a sidewall 40a. In this manner, the transparent dome 30 is locked into position relative to the top portion 26 and the base portion 22. This locking mechanism 34 provides additional stacking strength which prevents the transparent dome 30 from being dislodged from the aperture 28 and contacting the contents of the combination bakery carton 20.

Illustrated in FIG. 4 is a combination bakery carton 20 depicted in the open configuration. The base portion 22 intersects the sidewalls 24a-24c along a fold line 42. The sidewalls 24a-24d when folded along the fold line 42 to a position substantially orthogonal to the base portion 22 cooperate to define an interior 44. The lid portion 26 intersects with the sidewall 24c along a fold line 46. The lid portion 26 is thereby pivotable about the fold line 46 from a closed position in which the lid portion 26 is substantially parallel to the base portion 22 to an open position in which the lid portion 26 allows access to the interior 44.

As can further be seen in FIG. 4, a plurality of covers 48a-48c intersect with the top portion 26 along the fold line 50. The covers 48a-48c when folded along fold line 50 to a position substantially orthogonal to the top portion 26 may act to protect the sidewalls 24a, 24b and 24d and provide additional area upon which information may be printed.

Illustrated in FIG. 5 is a magnified view of the locking system generally identified in FIG. 4 by the numeral 52. The locking system 52 includes a retaining flap 54 which intersects with the cover 48c along the fold line 56. The retaining flap 54 and the cover 48c cooperate to define a notch 58a. The sidewall 24d includes a groove 58b. The groove 58b is sized to interlock with the notch 58a when the sidewall 24d and 24c and the cover 48c are arranged such that they are substantially orthogonal to each other. When the sidewalls 24d and 24c and the cover 48c are arranged in such a manner, the notch 58a and groove 58b interact to seal and protect the contents of the interior 44.

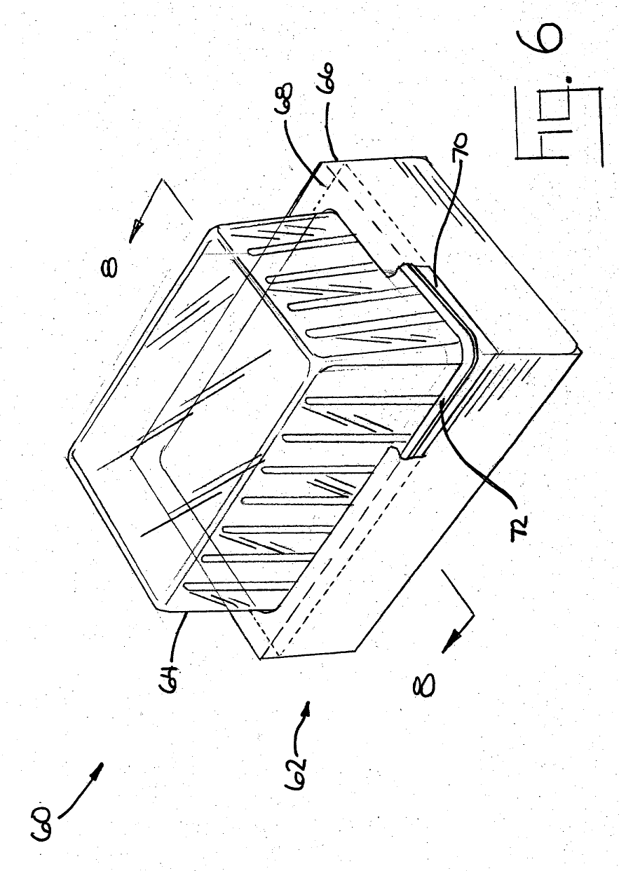

FIG. 6 illustrates another embodiment of a combination bakery carton generally identified by the numeral 60. The combination bakery carton 60 includes a base 62 and a transparent dome 64 acting in cooperation to form a single unit. The cavity 66 may be formed by the interaction of a lid surface 68 and a base surface 70. These two surfaces 68 and 70 when placed substantially parallel, relative to each other, form the cavity 66 which may be used to restrain a lip 72 integrally formed into the transparent dome 64. In this way the base 62 and the transparent dome 64 may be assembled to form a complete combination bakery carton 60.

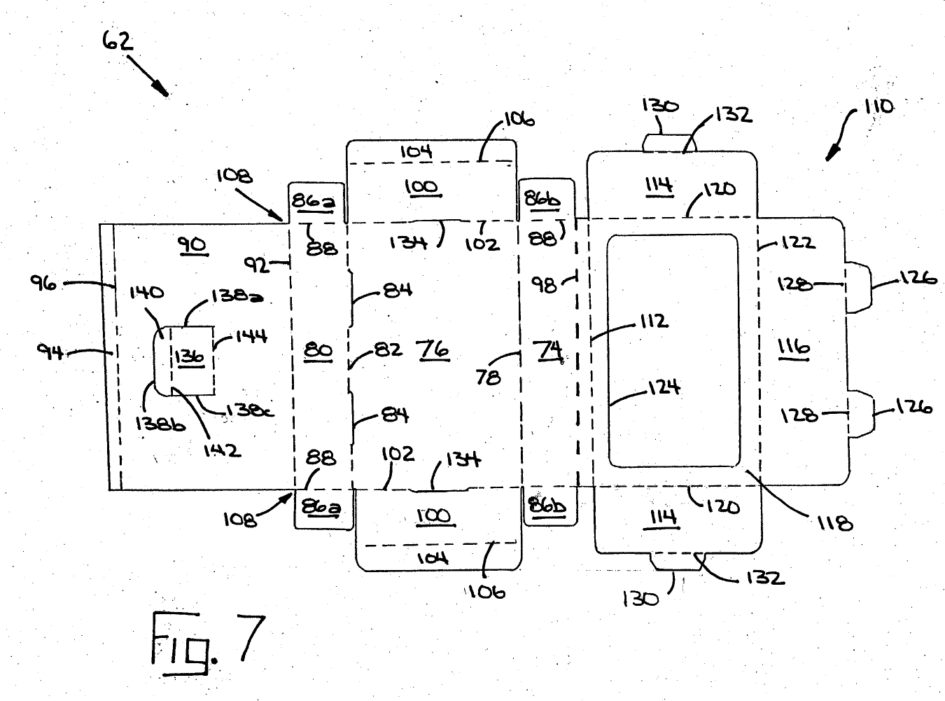

FIG. 7 illustrates the unerected blank of the base 62. The base 62 includes an extended sidewall 74 that intersects the base 76 along the fold line 78. The opposing side of the base 76 intersects the sidewall 80 along a fold line 82. The fold line 82 may include a plurality of locking slots 84. The sidewall 80 may further include a plurality of flaps 86a. The flaps 86a may be located transverse to the fold lines 82, the flaps 86a may intersect the sidewall 80 along fold line 88. The sidewall 80 may further intersects the top 90 along fold line 92. The top 90 includes a support flap 94 integrally formed along fold line 96.

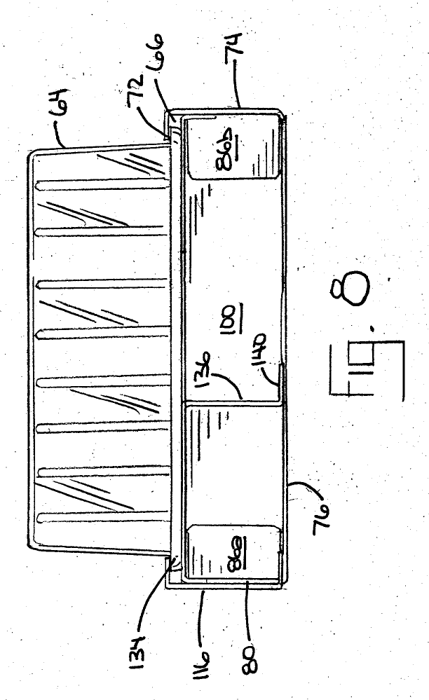

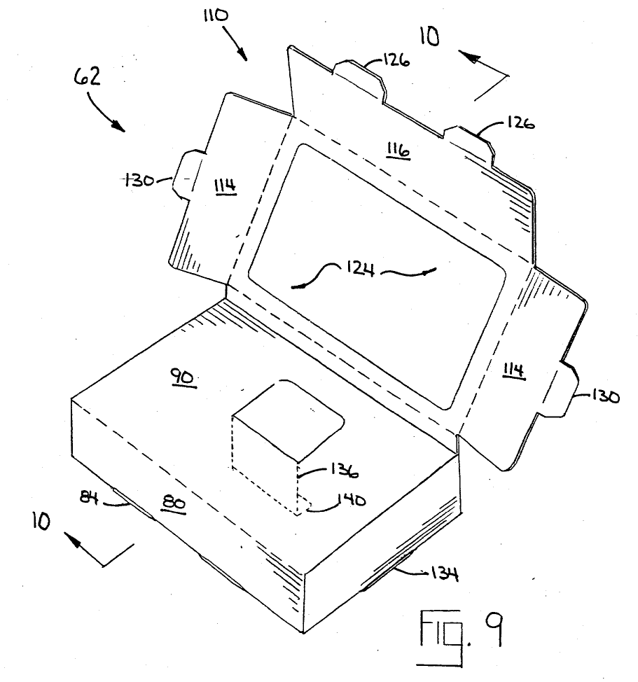

To erect the base 62, the extended sidewall 74 may be bent along fold line 78 until it is substantially orthogonal to the base 76. It should be noted that the extended sidewall 74 includes an additional pair of flaps 86b, these flaps 86b correspond to the flaps 86a attached to the sidewall 80. The sidewall 80 may be bent along fold line 82 until it is in a position substantially orthogonal to the base 76. At this point, the sidewall 80 and the extended sidewall 74 are substantially parallel with respect to each other. The top 90 may then be bent along fold line 92 until it is substantially parallel to the base 76. The top 90 may then be secured to the extended sidewall 74 by attaching the support flap 94 to the extended sidewall 74 along the line 98. At this point, a hollow sleeve has been created, as illustrated in FIGS. 8 and 10, from the extended sidewall 74, the base 76, the sidewall 80 and the top 90. The flaps 86a and 86b associated with extended sidewall 74 and the sidewall 80 may, at this point, be bent along the fold line 88 to reinforce the open ends of the sleeve created by the sidewalls and the base 74, 76, 80 and 90.

The base 76 may further include a plurality of endwalls 100. The plurality of endwalls 100 intersect the base 76 along fold line 102. The plurality of endwalls 100 may further contain a flap 104 integrally formed along the fold line 106. The endwall 100 may be bent along fold line 102 and cooperate with the extended sidewall 74 and the sidewall 80 to enclose the ends of the sleeve created by the sidewalls and the base 74, 76, 80 and 90. By folding the endwall 100 to a position substantially orthogonal to the base 76, the flap 104 may be inserted between a gap 108 created between the flap 86 and the bottom surface of the top 90. In this manner, an enclosed cavity may be erected as part of the base 62.

Further illustrated in FIG. 7 is an outer lid generally identified by the numeral 110. The outer lid 110 intersects the extended sidewall 74 along fold line 112. The outer lid 110 further includes a pair of side covers 114 and a front cover 116. The side covers 114 and the front cover 116 intersect the lid 118 along fold lines 120 and 122, respectively. The lid 118 further includes an aperture 124 sized to accept the dome portion 64 illustrated in FIG. 6.

The outer lid cover 110 may be bent along fold line 112 to a position substantially parallel to the top 90 and base 76. The front cover 116, from the parallel position, may be bent along fold line 122 to encompass sidewall 80. A plurality of flaps 126 may be formed integral to front cover 116 along a fold line 128. The flaps 126, when bent along fold lines 128, are arranged to engage the corresponding plurality of slots 84 which are located along fold line 82. The front cover 116, when arranged in this manner, cooperates with the sidewall 80 to position the lid 118 parallel to and at a fixed distance from the top 90. The side covers 114 may, in turn, be bent along folding line 120 to encompass the endwalls 100. A plurality of flaps 130 may be formed integrally to the side covers 114 along fold line 132. The flaps 130 may engage the with slots 134 formed into fold line 102 to secure the side covers 114 adjacent to the end covers 100. Further, when the flaps 130 cooperate with the slot 134, the cover lid 110 is held in a fixed position parallel to the top 90 and creating the cavity 66 illustrated in greater detail in FIG. 6.

FIG. 8 illustrates a sectional view taken along the lines 8-8 of the combination container assembled in the erect configuration. In this sectional view, the flaps 86a, 86b can be seen resting flush against the endwall 100. Further, the side cover 116 is illustrated adjacent to the sidewall 80 and secured by the flaps 126 interaction with the slots 84. The cavity 66, as illustrated in FIG. 6, is sized to accept the base 134. The base 134, in turn, engages the lip 72 of the transparent dome 64 to form a complete enclosure. A support 136 may be formed in the top 90 by separating the surrounding sides 138a-138c, as illustrated in FIG. 7, from the surrounding material. The support 136 includes a footer 140 formed integral to the support 136 along fold line 142. The remaining side of the support 136 is bendable along fold line 144. When the base 62 is in the erect position and the support 136 is bent inwards, towards the base 76, the footer 140 may be formed by bending it parallel to the base 76. In this manner, the support 136 may be fixedly attached to the base 76 by means of the footer 140 and provide additional support for the transparent dome 64 located in the cavity 66 directly adjacent to top 90.

FIG. 9 illustrates the base 62 in the open configuration. The side covers 114 and front cover 116 can be seen prior to engaging the sidewall 80 and end covers 100. Further, the vertical support 136 and footer 140 may be seen as hidden structures within the base 60.

FIG. 10 illustrates a cross-sectional view taken along the section line 10-10. The vertical support 136 and footer 140 may be seen to engage the base 76. Further, the lid cover 110 may be seen in the open configuration without the transparent dome 64 disposed within the aperture 124. As a result, the front cover 116 and the flaps 126 may be seen bent to engage the locking slots 84.

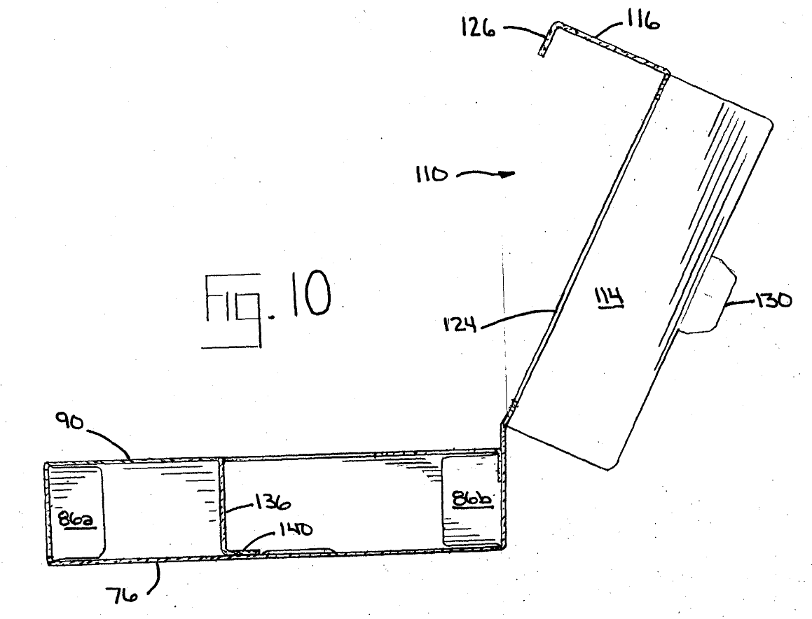

FIG. 11 illustrates another embodiment of the locking mechanism 34 detailed in FIG. 3. The locking mechanism 142 of FIG. 11 includes a detente 144 sized to accept the top portion 26. The detente 144 cooperates with lip 36 to secure the transparent dome 30 in a fixed position relative to the top portion 26 and the base portion 22.

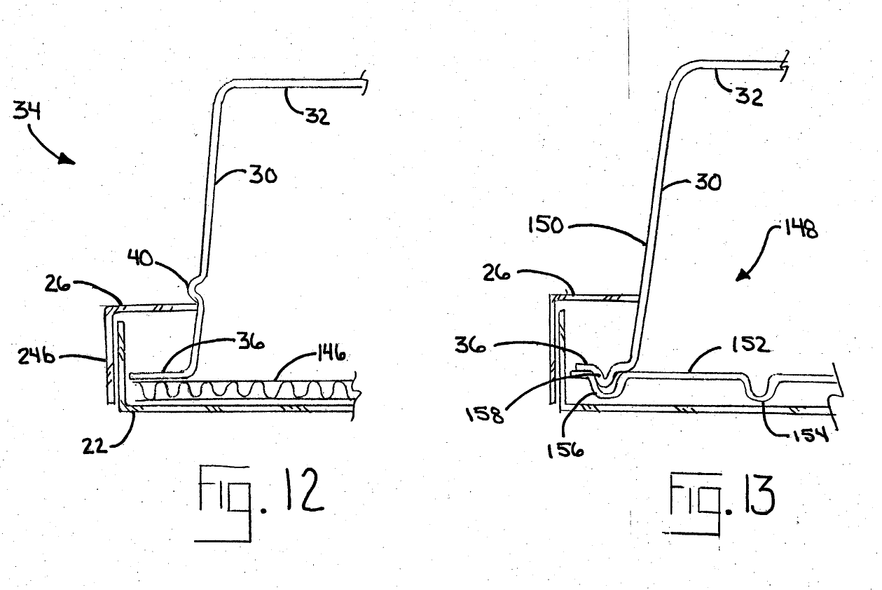

FIG. 12 illustrates another embodiment of the locking mechanism 34, shown in FIG. 3, acting in cooperation with a stiffening member 146. The stiffening member 146 may be utilized to provide additional support when heavy or fragile items are transported within the combination carton 20.

FIG. 13 illustrates another embodiment of the combination carton 20 adapted to cooperate with a dome assembly 148. The dome assembly 148 may include a transparent dome 150 and a complimentary base 152. The base 152 may include a plurality of support members 154 to strengthen an reinforce the structure. Further, the base 152 may be formed with a retaining member 156, the retaining member 156 adapted to accept a locking member 158 which may be formed integral to the lip 36 of the transparent dome 150. The resulting dome assembly 148 may or may not be secured to the top portion 26 and may be used independently of the combination carton 20.

While the present invention has been described with reference to specific embodiments which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A container for displaying bakery goods comprising:
a transparent dome, the transparent dome incorporating a locking member, and
a foldable carton, the foldable carton having a base portion,
a lid portion pivotably connected to the base portion,
an aperture formed within the lid portion and sized to receive the transparent dome, and
a plane defined by a surface of the lid portion, the transparent dome disposed within the aperture and extending through the surface and beyond the plane such that the locking member secures the transparent dome within the aperture.

2. The container of claim 1, wherein the foldable carton is a four spot carton.

3. The container of claim 1, wherein the foldable carton is constructed from laminated paper.

4. The container of claim 1, wherein the base portion further comprises a bottom surface:
a plurality of vertical members; and
a storage surface cooperating with the plurality of vertical members and the bottom surface to form an enclosed cavity.

5. The container of claim 4, wherein the base portion, the plurality of vertical members and the storage surface are constructed from corrugated paper.

6. The container of claim 1, wherein the lid portion further comprises a dust flap.

7. The container of claim 6, wherein the lid portion further comprises an engaging slot and a relief notch, the engaging slot and the relief notch acting in cooperation when the container is closed.

8. The container of claim 1, wherein the transparent dome is a plastic cake dome.

9. The container of claim 1, wherein the container further comprises:
a support member, the support member positioned adjacent to the base portion.

10. The container of claim 9, wherein the support member further includes a plurality of stiffening members.

11. The container of claim 9, wherein the locking system further includes a retaining member, the retaining member sized to cooperate with the aperture and secure the transparent dome relative to the lid portion.

12. The container of claim 9, wherein the locking system further comprises:
a retaining member integral to the transparent dome;
a securing member integral to the support member; and
the retaining member and the securing member cooperating to position the transparent dome within the aperture.

13. The container of claim 1, wherein the locking system further includes a retaining member adapted to cooperate with the aperture.

14. The container of claim 13, wherein the retaining member is shaped substantially concave.

15. The container of claim 13, wherein the retaining member is shaped substantially convex.

16. The container of claim 1, wherein the transparent dome is sized to engage the lid portion and the base portion.

17. A combination bakery container, the combination bakery container constructed to accept baked goods and other articles, the combination bakery container comprising:
a base surface, the base surface having a plurality of inner side members;
a storage surface cooperating with the plurality of inner side members to form a storage cavity;
a standoff member defined by the at least one of the plurality of side members extending past a plane defined by the storage surface;
a lid pivotably attached to the standoff member and having a plurality of outer side members;
a opening disposed within the lid and adapted to receive a display shell;
the display shell forming a hollow enclosure having a perimeter defining an open face;
a locking groove integrally formed into the perimeter, the locking groove providing a means for securing the display shell to a complementary display base;
a retention lip formed above the storage surface when the plurality of outer side members cooperate with the plurality of inner side members to secure the lid in a closed position; and
the retention lip adapted to secure the display shell and the complementary display base when the display shell and the display base are disposed within the opening provided in the lid.

18. The combination bakery container of claim 17, wherein display shell is constructed from a transparent material.

19. The combination bakery container of claim 17, wherein the plurality of outer side members are adapted to display text or graphics.

20. A method of constructing a combination bakery container, the method comprising the steps of:
folding a carton blank to form a lower storage unit;
providing a panel of the carton blank to form a lid portion and a plurality of side portions;
scoring a plurality of fold lines in the panel to form a pocket above an upper surface of the lower storage unit;
providing a display shell and a cooperating display base;
creating an opening in the lid portion, sized to receive the display shell and the cooperating display base;
inserting the display shell through the opening and securing the display shell and cooperating base within the pocket.

21. A foldable combination carton comprising:
a panel;
a lid, the lid having an aperture sized to accept a display shell;
wherein the lid is pivotable between an open position and a closed position, the lid when disposed in the closed position is at rest substantially parallel to the panel forming a pocket therebetween,
a display base, the display base adapted to cooperate with the display shell, the pocket adapted to secure the display base;
a storage cavity, the storage cavity formed by the cooperation of the panel and a plurality of foldable members.
